(19) United States
(12) Patent Application Publication
(10) Pub. No.: US 2012/0304645 A1
(43) Pub. Date: Dec. 6, 2012

(54) Fuel Cell Powered Jet Engine

(76) Inventor: Paul Benedict Huter, Harvest, AL (US)

(21) Appl. No.: 13/102,639

(22) Filed: May 31, 2011

(51) Int. Cl. F02C 1/05

(52) U.S. Cl. 60/682

(57) ABSTRACT

This invention is the use of a fuel cell for powering all the components of a jet engine, but especially heating elements used to heat the air moving through the engine, rather than burning jet fuel.

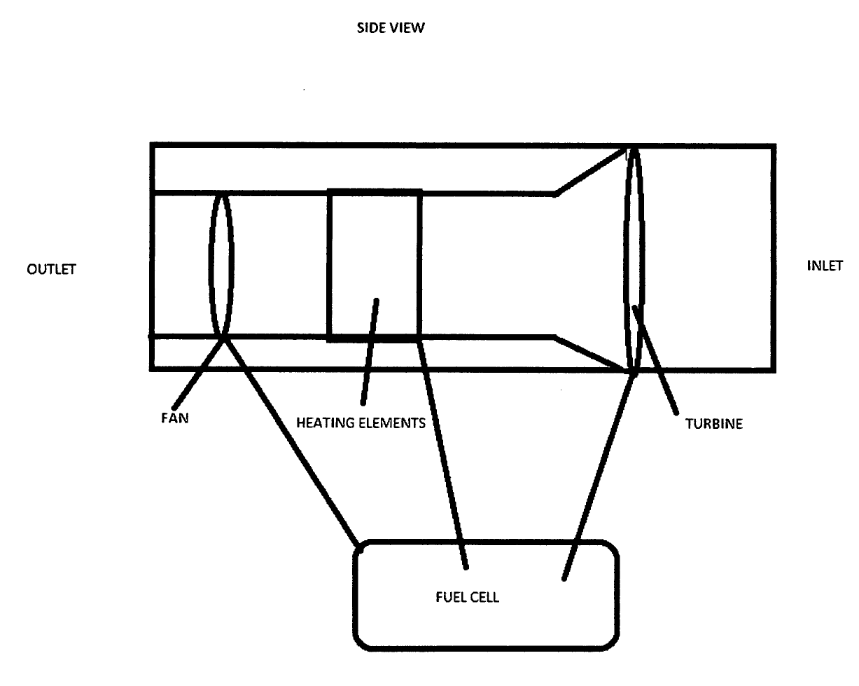

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING

Not Applicable

### BACKGROUND OF THE INVENTION

The purpose of this invention is to reduce emissions of aircraft that rely on jet engines for propulsion. It will also increase the capability of any jet that uses it, as a fuel cell requires less fuel than a conventional jet engine uses. The invention was originally envisioned to be used for powering a spacecraft through the atmosphere prior to lighting a rocket engine to reach low-Earth orbit.

### BRIEF SUMMARY OF THE INVENTION

A fuel cell has the capability to heat MoSi₂ heating elements to a temperature necessary for a jet engine to be functional. For example, an 80 kW fuel cell (such as the ones being utilized in automobiles) would be able to provide the 25.6 kW of power necessary to heat a chamber one meter in diameter by half a meter long containing eight heating elements to approximately 1200-degrees Celsius, well above the typical jet engine exhaust temperature of 600-degrees Celsius. This would leave 54.4 kW of power available for powering the other components of the jet engine. One fuel cell for each jet engine would use less fuel (liquid hydrogen and potentially liquid oxygen) than a conventional jet engine burning JP-8 jet fuel. The only byproduct of the engine would be water.

### BRIEF DESCRIPTION OF THE DRAWING

The attached drawing shows a side-view of the concept with the fuel cell attached to the heating elements and the turbine of the engine.

### DETAILED DESCRIPTION OF THE INVENTION

The invention differs from a typical jet engine in that rather than a section where the air is heated by burning jet fuel, it is heated by ceramic (likely MoSi₂) heating elements. As referenced in the brief summary, eight heating elements spaced evenly around a one meter diameter by one half meter chamber would heat the chamber to 1200-degrees Celsius. The fuel cell would be outside the engine and the liquid hydrogen (and potentially liquid oxygen) would be fed to the fuel cell from tanks either in the wings or elsewhere on the aircraft or spacecraft.

1. the use of a fuel cell and heating elements to provide the heat necessary for a jet engine to produce the thrust, AND

2. The use of a fuel cell to power the other components of the jet engine (turbine, etc.).
